(19) United States
(12) Patent Application Publication
(10) Pub. No.: US 2023/0015168 A1
(43) Pub. Date: Jan. 19, 2023

(54) USER EQUIPMENT PROCESSING LIMITS FOR UPLINK OR DOWNLINK DATA TRANSMISSIONS WITH REPETITIONS

(71) Applicant: Apple Inc., Cupertino, CA (US)

(72) Inventors: Sigen Ye, Whitehouse Station, NJ (US); Dawei Zhang, Saratoga, CA (US); Chunhai Yao, Beijing (CN); Chunxuan Ye, San Diego, CA (US); Hong He, San Jose, CA (US); Haitong Sun, Cupertino, CA (US); Yushu Zhang, Beijing (CN); Seyed Ali Akbar Fakoorian, San Diego, CA (US); Weidong Yang, San Diego, CA (US); Oghenekome Oteri, San Diego, CA (US); Wei Zeng, Saratoga, CA (US)

(21) Appl. No.: 17/375,924

(22) Filed: Jul. 14, 2021

(51) Int. Cl. H04W 72/12; H04W 72/04; H04L 1/00

(52) U.S. Cl. CPC H04W 72/1268; H04W 72/0446; H04W 72/0466; H04L 1/0003

(57) ABSTRACT

The present application relates to devices and components including apparatus, systems, and methods for limiting processing associated with multiple repetitions of an uplink or downlink transmission in wireless communication systems.

### BACKGROUND

Third Generation Partnership Project (3GPP) Fifth Generation (5G) New Radio (NR) networks may implement uplink data transmissions with repetitions, which may support lower latency and/or higher reliability.

### BRIEF DESCRIPTION OF THE DRAWINGS

FIG. 1 shows a network environment in accordance with some embodiments.

FIG. 2 shows one example of a PUSCH repetition Type B configuration in accordance with some embodiments.

FIG. 3 shows one example of a PUSCH repetition Type B configuration in accordance with some embodiments.

FIG. 4 shows one example of a PUSCH repetition Type B configuration in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates an operational flow/algorithmic structure in accordance with some embodiments.

FIG. 10 shows an example of a slot in accordance with some embodiments.

FIG. 11 illustrates an operational flow/algorithmic structure in accordance with some embodiments.

FIG. 12 illustrates an operational flow/algorithmic structure in accordance with some embodiments.

FIG. 13 illustrates an operational flow/algorithmic structure in accordance with some embodiments.

FIG. 14 shows an example of a slot in accordance with some embodiments.

FIG. 15 illustrates an operational flow/algorithmic structure in accordance with some embodiments.

FIG. 16 illustrates an operational flow/algorithmic structure in accordance with some embodiments.

FIG. 17 illustrates an operational flow/algorithmic structure in accordance with some embodiments.

FIG. 18 illustrates an operational flow/algorithmic structure in accordance with some embodiments.

FIG. 19 illustrates a user equipment in accordance with some embodiments.

FIG. 20 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). For the purposes of the present document, the phrase “A is based on B” means “A is based on at least B”.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

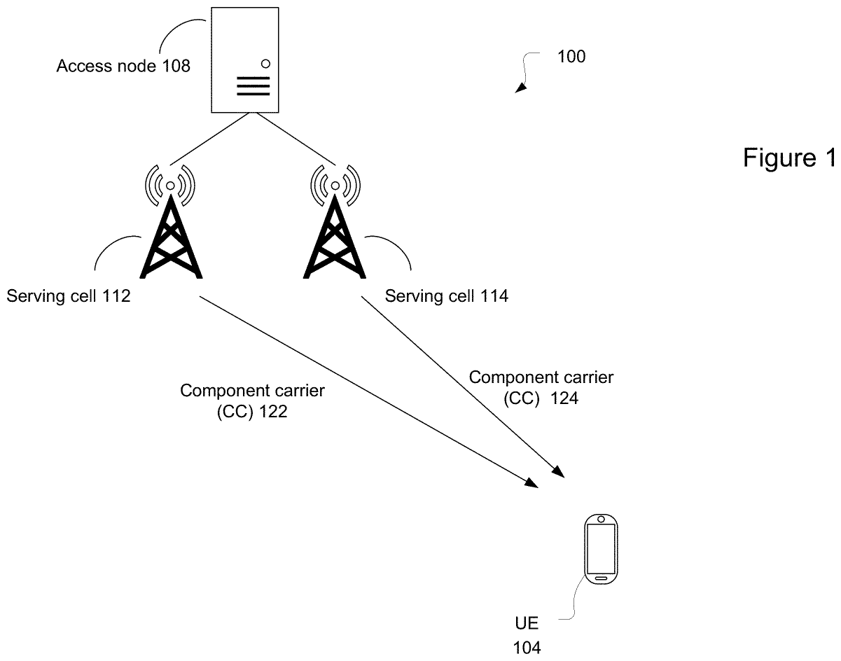

Techniques for limiting UE processing requirements for data transmissions with repetitions are described herein, with respect to both uplink and downlink data transmissions. FIG. 1 illustrates a network environment 100 in accordance with some embodiments. The network environment 100 may include a UE 104 and an access node (or “base station”) 108. The access node 108 may provide one or more wireless serving cells 112 and 114, for example, 3GPP New Radio “NR” cells, through which the UE 104 may communicate with the access node 108 (e.g., over an NR-Uu interface). In some aspects, the access node 108 is a Next Generation NodeB (gNB) that provides one or more 3GPP NR cells.

The access node 108 may transmit information (for example, data and control signaling) in the downlink direction by mapping logical channels on the transport channels, and transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink shared channel (PDSCH); and a physical downlink control channel (PDCCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, a Master Information Block (MIB)), and paging messages.

The access node 108 (e.g., base station or gNB) may use a PDCCH to transmit downlink control information (DCI) to the UE 104. The DCI may provide uplink resource allocations on a physical uplink shared channel (PUSCH), downlink resource allocations on a PDSCH, and various other control information. The DCI may also be used to provide uplink power control commands, configure a slot format, or indicate that preemption has occurred.

The access node (e.g., base station or gNB) 108 may also transmit various reference signals to the UE 104. A Reference Signal (RS) is a special signal that exists only at PHY layer and is not for delivering any specific information (e.g., data), but whose purpose instead is to deliver a reference point for transmitted power. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel state information-reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization. For example, the SSBs and CSI-RSs may be measured by the UE 104 to determine the desired downlink beam pair for transmitting/receiving PDCCH and physical downlink shared channel (PDSCH) transmissions. The UE 104 may use a Physical Uplink Control Channel (PUCCH) to transmit uplink control information (UCI) to the access node 108, including, for example, hybrid-automatic repeat request (HARQ) acknowledgements, scheduling requests, and periodic and semi-persistent channel state information (CSI) reports.

The UE 104 may include enhanced Multiple-Input-Multiple-Output (eMIMO) capabilities that support simultaneous communication over beams from several (or even many) different serving cells. FIG. 1 shows an example of carrier aggregation (CA), in which the UE 104 receives data from access node 108 simultaneously from serving cell 112 over a component carrier (CC) 122 and from serving cell 114 over a component carrier (CC) 124.

The CC 122 may be in a band in Frequency Range 1 (FR1) or in Frequency Range 2 (FR2). Likewise the CC 124 may be in a band in FR1 or in FR2. The CCs 112 and 124 may be in the same band (intra-band, either contiguous or non-contiguous) or may be in different bands (inter-band) and possibly different frequency ranges. For FR1 (e.g., below 7.225 GHz), a transmit antenna of the UE 104 is typically implemented as an omnidirectional antenna. For FR2 (e.g., 24.250 GHz and above, also called mmWave), a transmit antenna of the UE 104 may be implemented as a panel having multiple antenna elements. For example, the multiple antenna elements of a panel may be driven as a phased array (e.g., to direct a beam in a desired direction).

A 5G network may implement PUSCH repetition Type B, which supports multiple repetitions of a PUSCH transmission in one slot and/or repetitions of the same PUSCH transmission across multiple slots. Such an implementation may be used, for example, to achieve a desired level of low latency and/or high reliability. A UE 104 may transmit repetitions of a PUSCH transmission within the same slot and/or on the same carrier as other uplink transmission instances. For example, the UE 104 may transmit the repetitions within the same slot and/or on the same carrier as one or more regular PUSCH transmissions. Additionally or alternatively, the UE 104 may transmit repetitions of a PUSCH transmission within the same slot and/or on the same carrier as repetitions of another PUSCH transmission. The UE may transmit uplink transmission instances on the same uplink beam or on different uplink beams. For example, the UE may transmit the repetitions of a PUSCH transmission on the same uplink beam or on different uplink beams. A UE 104 may also transmit repetitions of a PUSCH transmission on a different carrier than other uplink transmission instances (e.g., one or more regular PUSCH transmissions, repetitions of another PUSCH transmission), possibly within the same slot.

A base station 108 may communicate a PUSCH repetition Type B configuration to a UE 104 by providing a slot configuration and scheduling information. The slot configuration indicates symbols within a time period that are available for uplink transmission, and the base station 108 may provide the slot configuration in, for example, an RRC signaling message or a DCI message. The scheduling information may include a time domain resource allocation, a modulation and coding scheme (MCS), and/or a frequency resource allocation (which may indicate, for example, a number of physical resource blocks (PRBs)) and may be provided, for example, in one or more RRC messages and/or one or more DCI messages. PUSCH repetition Type B may be supported for both dynamic grant (DG) and configured grant (CG). In the case of CG, PUSCH repetition Type B may be supported for Type 1 and/or Type 2. PUSCH repetition Type B may be scheduled by DCI format 0_1 or DCI format 0_2 but typically is not scheduled by DCI format 0_0.

The time domain resource allocation of a particular PUSCH repetition Type B configuration is defined by values of parameters S (starting symbol), L (length of each nominal repetition) and K (number of nominal repetitions). The base station 108 may use the time domain resource allocation field (TDRA field) in a DCI message or in a Type 1 CG configuration message to communicate values for S, L and K to the UE 104. For example, the TDRA field may indicate one of the entries in a time domain resource allocation table (TDRA table) that is known to the base station 108 and the UE 104, where the table entry provides the values for S, L and K. The PUSCH transmission may occur within a time window of L*K symbols that starts at the starting symbol indicated by the value of S. The time domain resource allocation may be over one slot or over consecutive slots, although the actual transmissions may not be in consecutive slots (e.g., if there is a downlink (DL) slot in the middle).

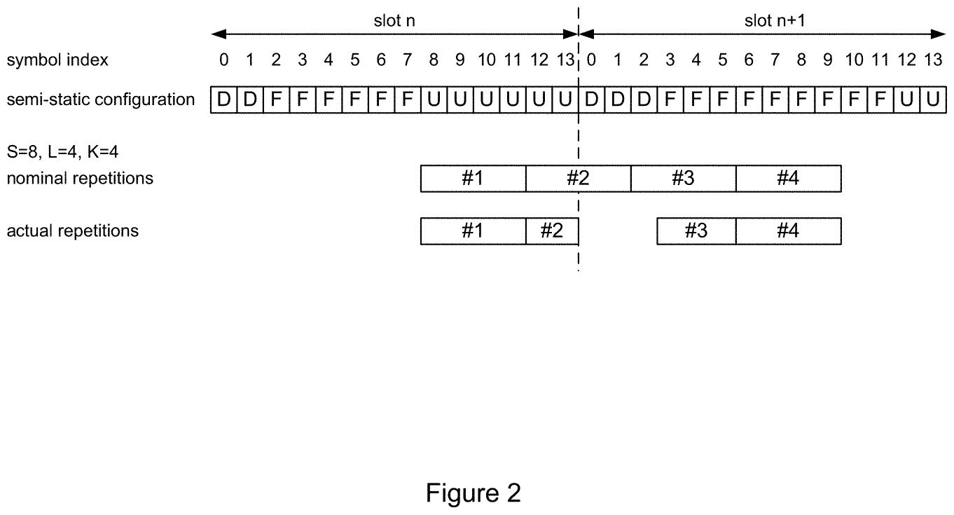

FIG. 2 shows one example of a PUSCH repetition Type B configuration defined by the values S=8, L=4, K=4 as applied to a given semi-static time-domain duplex (TDD) slot format configuration that includes DL symbols (‘D’), uplink (UL) symbols (‘U’), and flexible symbols (‘F’). The base station 108 may send the slot configuration to the UE 104 in a message that is different from the one that carries the time domain resource allocation. As discussed, for example, in section 11.1 of 3GPP TS 38.213 v 16.5.0 (2021-04), the base station 108 may send a static or semi-static slot configuration to UE 104 using a radio resource control (RRC) signaling message and may send a dynamic slot configuration to UE 104 using a DCI message on PDCCH. FIG. 2 shows an example in which the values of S, L, and K and the semi-static slot configuration describe a repetition configuration in which fewer than L consecutive symbols are available for each of actual repetition #2 and actual repetition #3.

As noted above, a DMRS may be used to estimate the radio channel for demodulation. PUSCH repetition Type B may be implemented so that DMRSs are not shared across multiple repetitions. PUSCH repetition Type B may also be implemented so that only PUSCH mapping type B is supported and/or so that transport block size (TBS) is determined based on the value of parameter L (length of each nominal repetition).

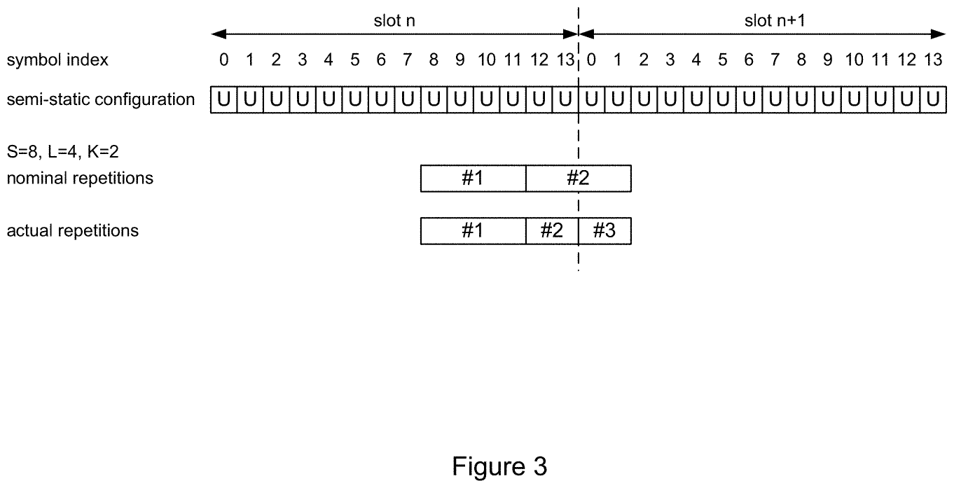

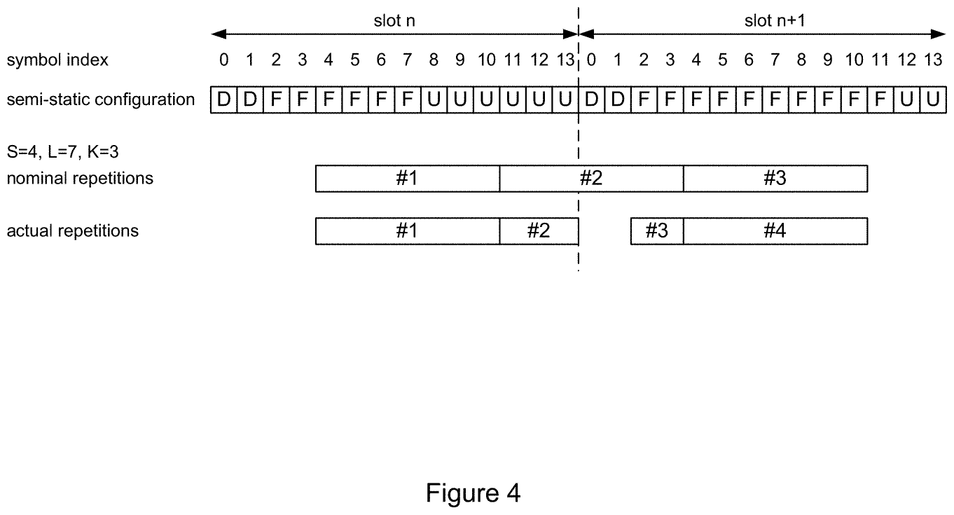

PUSCH repetition Type B may be implemented to support segmentation. Segmentation may occur, for example, if one of the nominal repetitions as allocated extends across a slot boundary (e.g., as shown in FIG. 3) or extends across DL symbols or symbols that are otherwise unavailable (e.g., as shown in FIG. 4). Each nominal repetition may be segmented into one or more actual repetitions, depending on the slot boundaries and/or the UL/DL directions of the symbols, so that the actual number of repetitions as scheduled for a PUSCH transmission can be larger than the nominal number. For example, if a “nominal” repetition extends across the slot boundary or DL/UL switching point, this “nominal” repetition is split into multiple PUSCH repetitions, with one PUSCH repetition in each UL period in a slot.

Support for PUSCH repetition Type B in a 5G network may give rise to issues relating to UE implementation complexity. A UE's processing power may be dimensioned based on factors such as, for example, the expected maximum code rate and/or data rate for each transmission that the UE may need to process, the expected maximum code rate and/or data rate for all of the transmissions that the UE may need to process within a certain time period (e.g., a slot), etc. PUSCH repetition Type B may create challenges for UE dimensioning. As discussed below, similar challenges may arise for DL transmission with repetitions on PDSCH.

For PUSCH repetition Type B, the TBS may be determined based on the nominal duration L. As noted above, a nominal repetition may be segmented into one or more actual repetitions. If the duration of an actual repetition as scheduled is significantly shorter than the duration L of a nominal repetition, the effective code rate of the actual repetition may be much higher than the nominal code rate as indicated by the modulation and coding scheme (MCS), which could create a significant and sometimes unnecessarily high processing burden for the UE if the actual is transmitted.

An example of such an issue is discussed with reference to FIG. 2. In this discussion, it is assumed that an MCS index of 16 (from Table 6.1.4.1-1 of 3GPP TS 38.214 v16.5.0 (2021-04)) is indicated, corresponding to a target nominal code rate of 658/1024. A nominal repetition has 4 symbols (e.g., as indicated by the value of L), with one DMRS symbol and three data symbols. However, the actual repetition #2 as scheduled has only two symbols, with one DMRS symbol and only one data symbol. With TBS being determined based on L=4, the effective code rate of the actual repetition #2 is 1974/1024, which is greater than 1.9 or roughly three times the target nominal code rate.

Moreover, a slot may include multiple actual repetitions for a PUSCH repetition Type B that correspond to the same TB. FIG. 2 shows an example that includes two actual repetitions scheduled for slot n (and two more actual repetitions scheduled for slot n+1), all corresponding to uplink transmission of the same TB. A TB with multiple actual repetitions within a slot may be more complicated for a UE to process than a TB not using a repetition scheme or a TB with only a single actual repetition within a slot.

For any of such reasons (e.g., to alleviate UE implementation burden), it may be desired to implement a procedure for handling PUSCH repetition Type B. Note that if a similar repetition scheme is adopted for downlink data transmission (e.g., on the PDSCH), issues similar to those as described herein with reference to PUSCH repetition Type B may also arise. Accordingly, the techniques disclosed herein with reference to uplink data transmission repetition may also be applied to downlink data transmission repetition (e.g., for dimensioning of UE processing power, etc.).

Techniques that may be implemented to limit UE processing requirements for data transmissions with repetitions are presented. These techniques may include an upper limit on the maximum data rate for actual repetitions of PUSCH repetition Type B and/or an upper limit on the maximum code rate for actual repetitions of PUSCH repetition Type B. An upper limit on the maximum data rate or maximum code rate may be defined for each actual repetition itself. Alternatively or additionally, an upper limit on the maximum data rate or maximum code rate may be defined for one or more actual repetitions as combined with other PUSCH transmissions (e.g., an aggregated maximum data rate or aggregated maximum code rate). When such a defined limit is exceeded, the UE may not be required to process and/or to transmit the corresponding PUSCH transmission(s), and/or the event may be considered as an error case. For example, detecting that the limit is exceeded may cause the UE to determine not to transmit any or all of the corresponding PUSCH transmission(s).

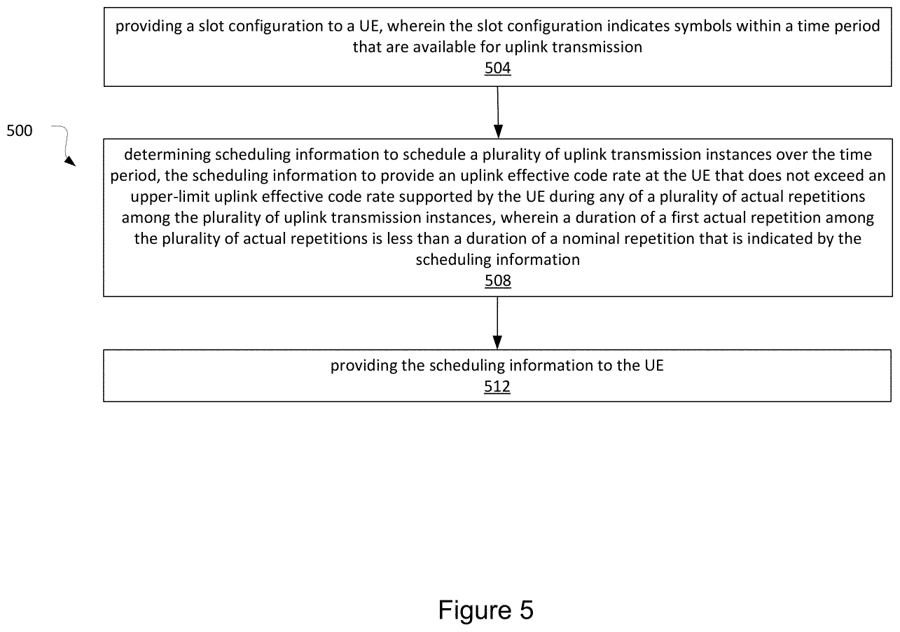

FIG. 5 illustrates an operation flow/algorithmic structure 500 in accordance with some embodiments. The operation flow/algorithmic structure 500 may be performed or implemented by a base station such as, for example, base station 108 or 2000; or components thereof, for example, baseband processor 2004A.

The operation flow/algorithmic structure 500 may include, at block 504, providing a slot configuration to a UE, wherein the slot configuration indicates symbols within a time period (e.g., one or more slots) that are available for uplink transmission.

The operation flow/algorithmic structure 500 may include, at block 508, determining scheduling information to schedule a plurality of uplink transmission instances over the time period. The plurality of uplink transmission instances includes a plurality of actual repetitions for an uplink transmission (e.g., a PUSCH transmission), and the scheduling information is to provide an uplink effective code rate at the UE that does not exceed an upper-limit uplink effective code rate supported by the UE during any of the plurality of actual repetitions. The scheduling information may include, for example, a time domain resource allocation, a modulation and coding scheme, and/or a frequency resource allocation. A duration of a first actual repetition among the plurality of actual repetitions may be less than a duration of a nominal repetition of the uplink transmission that is indicated by the scheduling information. The scheduling information may indicate that the plurality of actual repetitions are for a first carrier, and the plurality of uplink transmission instances may also include at least one uplink transmission instance for a second carrier that is different from the first carrier. Determining the scheduling information may include, for example, calculating the uplink effective code rate of the UE over the first actual repetition (which may be the shortest among the plurality of actual repetitions) and/or verifying that the uplink effective code rate does not exceed the upper-limit uplink effective code rate supported by the UE. The upper-limit uplink effective code rate may be the same as if PUSCH repetition Type B is not implemented. The upper-limit uplink effective code rate may be pre-defined or configured by higher layer signaling. For example, the upper-limit uplink effective code rate may be 0.95 or 948/1024, which makes each actual repetition self-decodable if the repetition has Redundancy Version (RV) 0 or 3. Alternatively, the upper-limit uplink effective code rate may be larger than 1, which may support combining gain with other repetitions.

The operation flow/algorithmic structure 500 may include, at block 512, providing the scheduling information to the UE in, for example, one or more messages (e.g., one or more DCI messages).

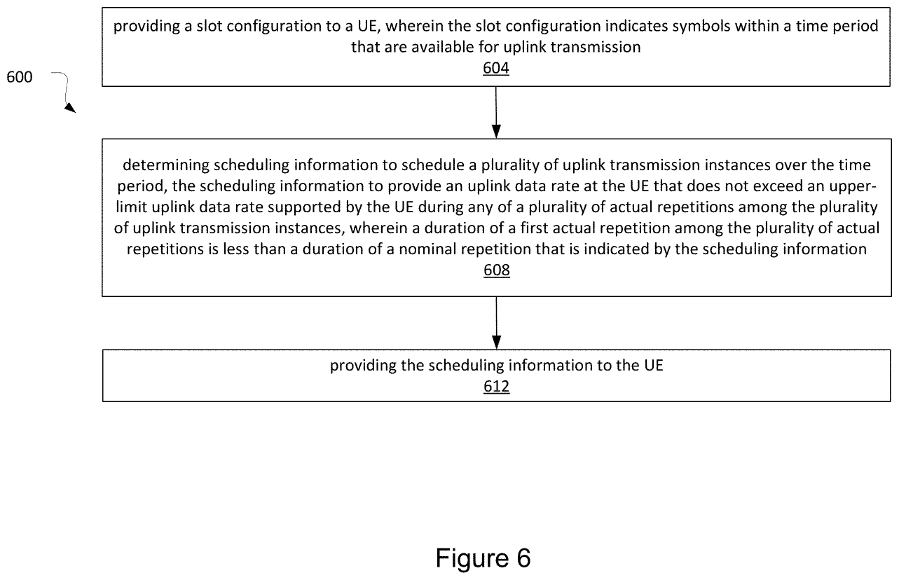

FIG. 6 illustrates an operation flow/algorithmic structure 600 in accordance with some embodiments. The operation flow/algorithmic structure 600 may be performed or implemented by a base station such as, for example, base station 108 or 2000; or components thereof, for example, baseband processor 2004A.

The operation flow/algorithmic structure 600 may include, at block 604, providing a slot configuration to a UE, wherein the slot configuration indicates symbols within a time period (e.g., one or more slots) that are available for uplink transmission.

The operation flow/algorithmic structure 600 may include, at block 608, determining scheduling information to schedule a plurality of uplink transmission instances over the time period. The plurality of uplink transmission instances includes a plurality of actual repetitions for an uplink transmission (e.g., a PUSCH transmission), and the scheduling information is to provide an uplink data rate at the UE that does not exceed an upper-limit uplink data rate supported by the UE during any of the plurality of actual repetitions. The scheduling information may include, for example, a time domain resource allocation, a modulation and coding scheme, and/or a frequency resource allocation. A duration of a first actual repetition among the plurality of actual repetitions may be less than a duration of a nominal repetition of the uplink transmission that is indicated by the scheduling information. The scheduling information may indicate that the plurality of actual repetitions are for a first carrier, and the plurality of uplink transmission instances may also include at least one uplink transmission instance for a second carrier that is different from the first carrier. Determining the scheduling information may include, for example, calculating the uplink data rate of the UE over the first actual repetition (which may be the shortest among the plurality of actual repetitions) and/or verifying that the uplink data rate does not exceed the upper-limit uplink data rate supported by the UE. The upper-limit uplink data rate may be the same as if PUSCH repetition Type B is not implemented. For example, the upper-limit uplink data rate may be calculated (e.g., by the base station 108) based on one or more capabilities as reported by the UE 104 (e.g., via capability signaling), such as the maximum number of supported MIMO layers, the maximum modulation order, the maximum bandwidth for the serving cell (e.g., with or without a scaling factor applied), and/or a scaling factor.

The operation flow/algorithmic structure 600 may include, at block 612, providing the scheduling information to the UE in, for example, one or more messages (e.g., one or more DCI messages).

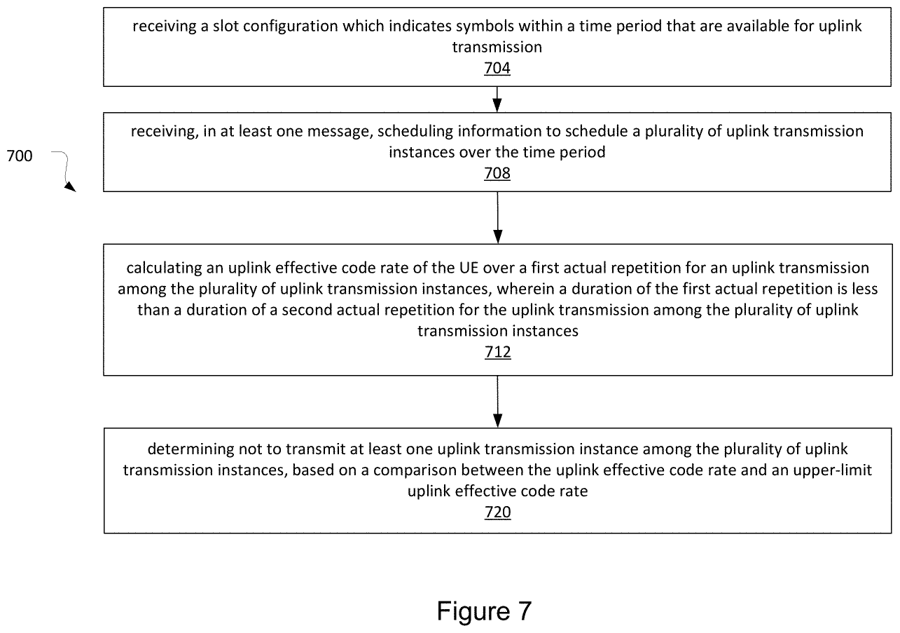

FIG. 7 illustrates an operation flow/algorithmic structure 700 in accordance with some embodiments. The operation flow/algorithmic structure 700 may be performed or implemented by a UE such as, for example, UE 104 or UE 1900; or components thereof, for example, baseband processor 1904A.

The operation flow/algorithmic structure 700 may include, at block 704, receiving a slot configuration which indicates symbols within a time period (e.g., one or more slots) that are available for uplink transmission. The operation flow/algorithmic structure 700 may include, at block 708, receiving, in at least one message (e.g., in at least one DCI message), scheduling information to schedule a plurality of uplink transmission instances over the time period. The plurality of uplink transmission instances includes a plurality of actual repetitions for an uplink transmission (e.g., a PUSCH transmission). The scheduling information may include, for example, a time domain resource allocation, a modulation and coding scheme, and/or a frequency resource allocation. The scheduling information may indicate that the plurality of actual repetitions are for a first carrier, and the plurality of uplink transmission instances may also include at least one uplink transmission instance for a second carrier that is different from the first carrier.

The operation flow/algorithmic structure 700 may include, at block 712, calculating an uplink effective code rate of the UE over a first actual repetition among the plurality of actual repetitions. A duration of the first actual repetition may be less than a duration of a nominal repetition of the uplink transmission that is indicated by the scheduling information.

The operation flow/algorithmic structure 700 may include, at block 720, determining not to transmit the actual repetition, based on a comparison between the calculated uplink effective code rate and an upper-limit uplink effective code rate. The upper-limit uplink effective code rate may be pre-defined or configured by higher layer signaling. For example, the upper-limit uplink effective code rate may be 0.95 or 948/1024, which makes each actual repetition self-decodable if the repetition has Redundancy Version (RV) 0 or 3. Alternatively, the upper-limit uplink effective code rate may be larger than 1, which may support combining gain with other repetitions.

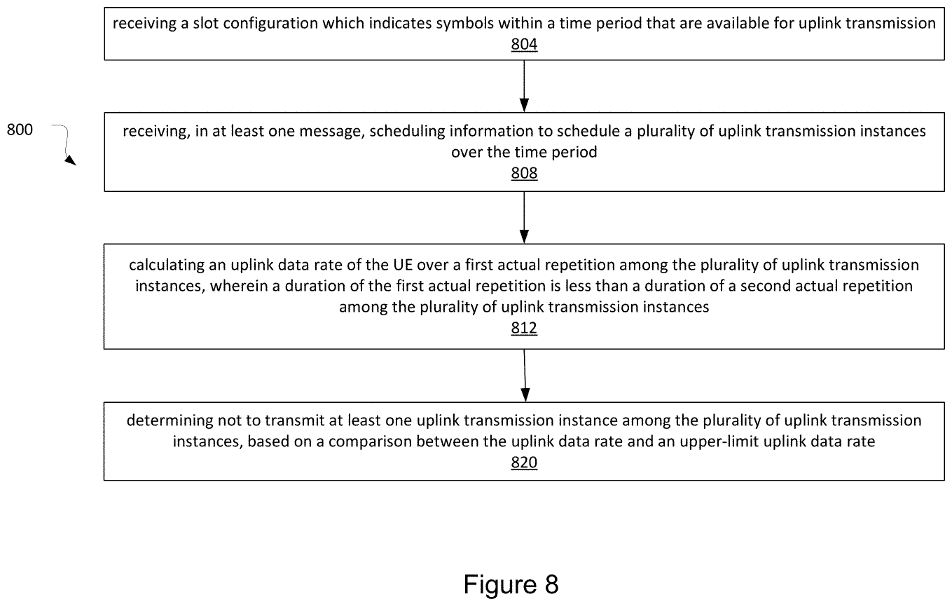

FIG. 8 illustrates an operation flow/algorithmic structure 800 in accordance with some embodiments. The operation flow/algorithmic structure 800 may be performed or implemented by a UE such as, for example, UE 104 or UE 1900; or components thereof, for example, baseband processor 1904A.

The operation flow/algorithmic structure 800 may include, at block 804, receiving a slot configuration which indicates symbols within a time period (e.g., one or more slots) that are available for uplink transmission. The operation flow/algorithmic structure 800 may include, at block 808, receiving, in at least one message (e.g., in at least one DCI message), scheduling information to schedule a plurality of uplink transmission instances over the time period. The plurality of uplink transmission instances includes a plurality of actual repetitions for an uplink transmission (e.g., a PUSCH transmission). The scheduling information may include, for example, a time domain resource allocation, a modulation and coding scheme, and/or a frequency resource allocation. The scheduling information may indicate that the plurality of actual repetitions are for a first carrier, and the plurality of uplink transmission instances may also include at least one uplink transmission instance for a second carrier that is different from the first carrier.

The operation flow/algorithmic structure 800 may include, at block 812, calculating an uplink data rate of the UE over a first actual repetition among the plurality of actual repetitions. A duration of the first actual repetition may be less than a duration of a nominal repetition of the uplink transmission that is indicated by the scheduling information.

The operation flow/algorithmic structure 800 may include, at block 820, determining not to transmit the actual repetition, based on a comparison between the calculated uplink data rate and an upper-limit uplink data rate. The upper-limit uplink data rate may be the same as if PUSCH repetition Type B is not implemented. For example, the upper-limit uplink data rate may be based on one or more capabilities of UE 104, such as the maximum number of supported MIMO layers, the maximum modulation order, the maximum bandwidth for the serving cell (e.g., with or without a scaling factor applied), and/or a scaling factor.

From a scheduling point of view, it may be more restrictive to apply an upper limit on effective code rate (e.g., as described with reference to operation flow/algorithmic structures 500 and 700) than to apply an upper limit on data rate (e.g., as described with reference to operation flow/algorithmic structures 600 and 800). For example, applying an upper limit on effective code rate may be more restrictive due to the explicit code rate limitation for each given transmission. Applying an upper limit on data rate, on the other hand, may be defined based on the maximum UE processing capability, which is typically more relaxed. It is also possible to combine an upper limit on effective code rate and an upper limit on data rate: for example, with a logical AND or a logical OR.

Whether an upper limit on effective code rate is applied or an upper limit on data rate is applied, an actual repetition may be fully or partially cancelled in case of intra-UE prioritization (e.g., due to another higher priority transmission) or in case of inter-UE cancellation (e.g., due to the reception of the UL cancellation indication). If an actual repetition is fully cancelled, the upper limit may be applied (e.g., by base station 108 or UE 104) based on the original length of the actual repetition or, alternatively, the upper limit may not be applicable. If an actual repetition is partially cancelled, the upper limit may be applied (e.g., by base station 108 or UE 104) either based on the original length of the actual repetition (before cancellation) or on the length of the actual repetition after partial cancellation.

As noted above, an upper limit on the maximum data rate or maximum code rate may be defined for one or more actual repetitions as combined with other PUSCH transmissions (e.g., an aggregated maximum data rate or aggregated maximum code rate over a time window). For example, it may be desired for the aggregated maximum data rate over a time window (e.g., over a slot) not to exceed the maximum data rate supported by the UE.

An aggregated maximum data rate over a slot may be calculated based on the number of TBs (e.g., as defined in clause 6.1.4 of 3GPP TS 38.214 v16.2.0 (2020-07)):

$${\sum }_{j = 0}^{J = 1} \frac{{Σ}_{m = 0}^{M = 1} {V}_{j , m}}{{T}_{slot}^{μ ( j )}}$$

where J is the number of configured serving cells that belong to a frequency range; and where for the j-th serving cell, M is the number of TBs transmitted in the slot, μ(j) is the numerology for PUSCH(s) in the slot, Tₛₗₒₜ^{μ(j)}=10⁻³2^{μ(j)}, and for the m-th TB,

$${V}_{j , m} = {C}^{′} \cdot \vert \frac{A}{C} \vert ,$$

where A is the number of bits in the transport block (e.g., as defined in Clause 6.2.1 of 3GPP TS 38.212 v16.2.0 (2020-07)), C is the total number of code blocks for the transport block (e.g., as defined in Clause 5.2.2 of 3GPP TS 38.212 v16.2.0), and C′ is the number of scheduled code blocks for the transport block (e.g., as defined in Clause 5.4.2.1 of TS 38.212 v16.2.0).

For a PUSCH repetition Type B, however, multiple actual repetitions that correspond to the same TB may occur within a slot. Because the multiple actual repetitions correspond to the same TB, a formula as described above with reference to clause 6.1.4 of 3GPP TS 38.214 v16.2.0 may count the TB only once in a slot, regardless of how many actual repetitions there are. As the UE complexity may depend on the number of repetitions within a slot, such an approach could require the UE to dimension for the worst case considering the maximum number of repetitions in a slot.

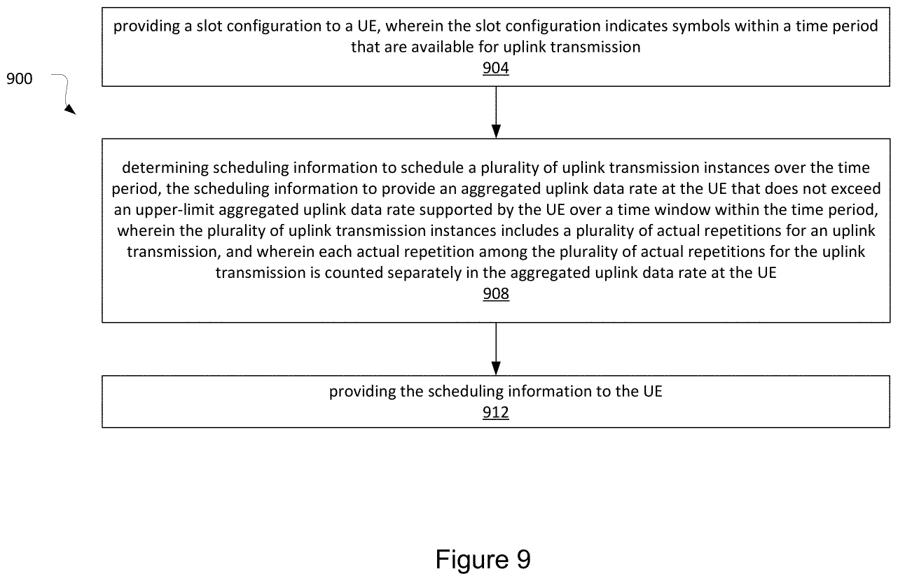

FIG. 9 illustrates an operation flow/algorithmic structure 900 in accordance with some embodiments. The operation flow/algorithmic structure 900 may be performed or implemented by a base station such as, for example, base station 108 or 2000; or components thereof, for example, baseband processor 2004A.

The operation flow/algorithmic structure 900 may include, at block 904, providing a slot configuration to a UE, wherein the slot configuration indicates symbols within a time period (e.g., one or more slots) that are available for uplink transmission.

The operation flow/algorithmic structure 900 may include, at block 908, determining scheduling information to schedule a plurality of uplink transmission instances over the time period, the scheduling information to provide an aggregated uplink data rate at the UE that does not exceed an upper-limit aggregated uplink data rate supported by the UE over a time window within the time period. The plurality of uplink transmission instances may include a plurality of actual repetitions for an uplink transmission, and each actual repetition among the plurality of actual repetitions for the uplink transmission may be counted separately in the aggregated uplink data rate at the UE. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. The scheduling information may include, for example, a time domain resource allocation, a modulation and coding scheme, and/or a frequency resource allocation. The scheduling information may indicate that the plurality of actual repetitions are for a first carrier, and the plurality of uplink transmission instances may also include at least one uplink transmission instance for a second carrier that is different from the first carrier. Determining the scheduling information may include, for example, calculating the aggregated uplink data rate at the UE over the time window and/or verifying that the aggregated uplink data rate does not exceed the upper-limit aggregated uplink data rate supported by the UE.

Calculating the aggregated uplink data rate may be performed for a single CC, for a group of CCs (for example, for CCs within a band, or for CCs within a band combination, or for CCs in a frequency range (e.g., FR1 or FR2)), or for all the CCs over which cells are currently serving the UE. As an example, the aggregated uplink data rate may be calculated in a similar manner as described above such that the condition for the aggregated uplink data rate across all CCs in a band or band combination in a slot may be defined as

$${\sum }_{j = 0}^{J - 1} \frac{{Σ}_{k = 0}^{K - 1} {V}_{j , k}}{{T}_{slot}^{μ ( j )}} \leq DataRate .$$

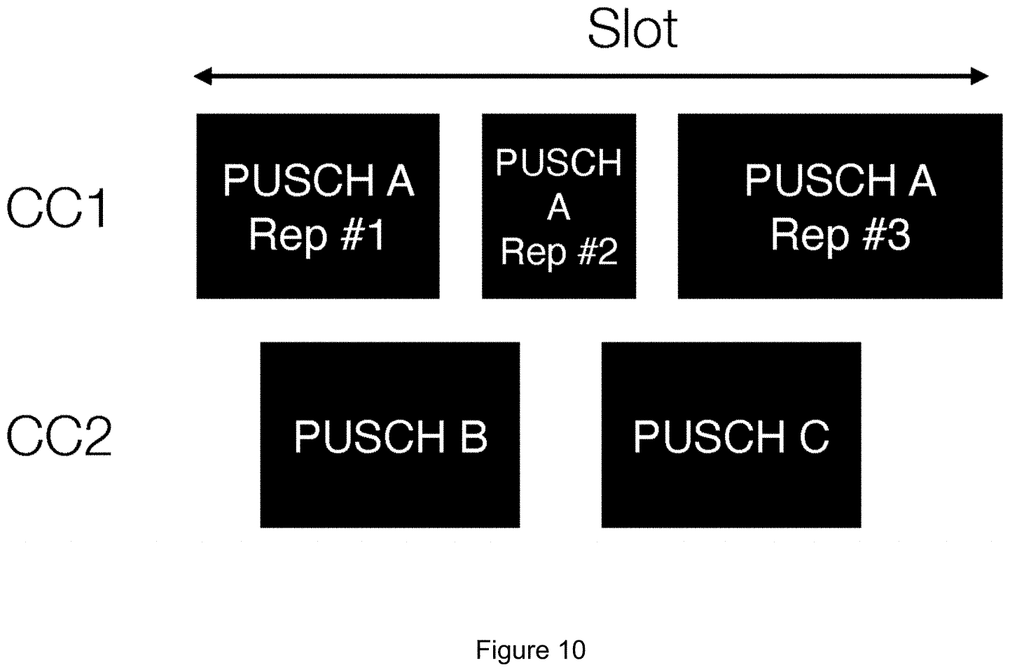

In this example, K denotes the total number of PUSCH transmissions and/or repetitions on all CCs in a slot, DataRate denotes an upper-limit aggregated uplink data rate, and all other parameters are as described above (e.g., with reference to clause 6.1.4 of 3GPP TS 38.214 v16.2.0). Note that each actual repetition is counted separately in this example, which allows the UE to treat each actual repetition as an independent transmission from the UE processing point of view. FIG. 10 shows an example of a slot in which K=5 (e.g., three actual repetitions of PUSCH A on CC1, a PUSCH transmission instance B on CC2, and a PUSCH transmission instance C on CC2).

The operation flow/algorithmic structure 900 may include, at block 912, providing the scheduling information to the UE in, for example, one or more messages (e.g., one or more DCI messages). Block 908 may also be implemented to include determining the scheduling information to provide an uplink data rate at the UE that does not exceed an upper-limit uplink data rate supported by the UE during any of the plurality of actual repetitions (e.g., as described herein with reference to block 608). Additionally or alternatively, block 908 may also be implemented to include determining the scheduling information to provide an uplink effective code rate at the UE that does not exceed an upper-limit uplink effective code rate supported by the UE during any of the plurality of actual repetitions (e.g., as described herein with reference to block 508), or determining the scheduling information to provide an uplink data rate at the UE that does not exceed an upper-limit uplink data rate supported by the UE during any of the plurality of actual repetitions (e.g., as described herein with reference to block 608).

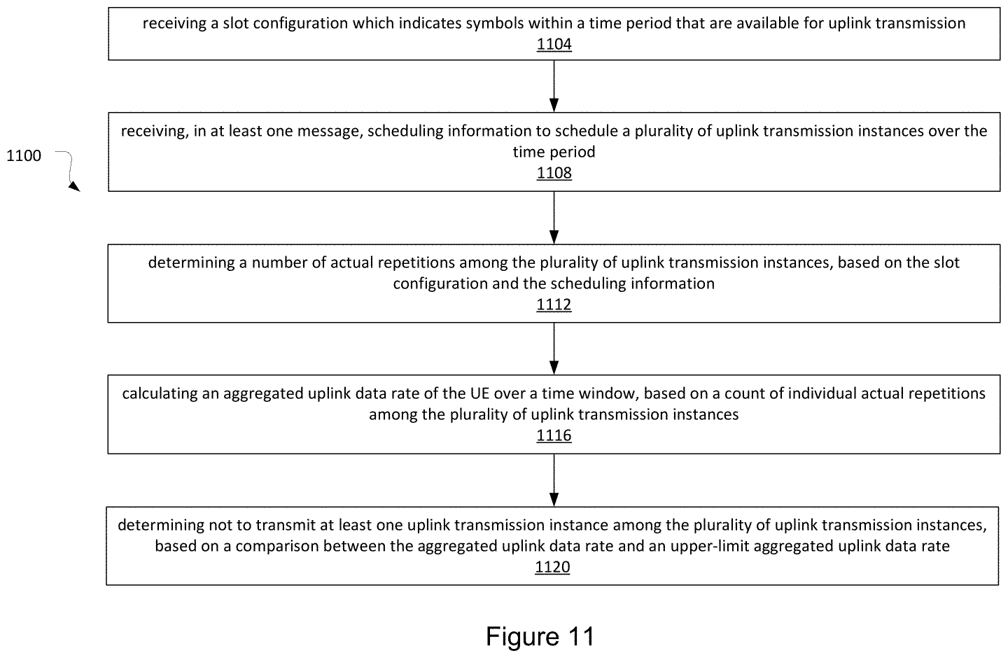

FIG. 11 illustrates an operation flow/algorithmic structure 1100 in accordance with some embodiments. The operation flow/algorithmic structure 1100 may be performed or implemented by a UE such as, for example, UE 104 or UE 1900; or components thereof, for example, baseband processor 1904A.

The operation flow/algorithmic structure 1100 may include, at block 1104, receiving a slot configuration which indicates symbols within a time period (e.g., one or more slots) that are available for uplink transmission. The operation flow/algorithmic structure 1100 may include, at block 1108, receiving, in at least one message (e.g., in at least one DCI message), scheduling information to schedule a plurality of uplink transmission instances over the time period. The scheduling information may include, for example, a time domain resource allocation, a modulation and coding scheme, and/or a frequency resource allocation.

The operation flow/algorithmic structure 1100 may include, at block 1112, determining a number of actual repetitions for an uplink transmission (e.g., a PUSCH transmission) among the plurality of uplink transmission instances, based on the slot configuration and the scheduling information. The number of actual repetitions within the time period may be greater than a number of nominal repetitions within the time period that is indicated by the scheduling information (e.g., by the time domain resource allocation). The scheduling information may indicate that the actual repetitions of the uplink transmission are for a first carrier, and the plurality of uplink transmission instances may also include at least one uplink transmission instance for a second carrier that is different from the first carrier.

The operation flow/algorithmic structure 1100 may include, at block 1116, calculating an aggregated uplink data rate of the UE over a time window, based on a count of individual actual repetitions of the uplink transmission. For example, calculating the aggregated uplink data rate of the UE over the time window may include counting each actual repetition among the number of actual repetitions separately towards the aggregated uplink data rate. The time window may be, for example, a slot, a sliding window with a fixed duration, the duration of an actual repetition, the duration of a nominal repetition, the combined durations of all the actual repetitions within a slot, or the combined duration of all the nominal repetitions within a slot.

Calculating the aggregated uplink data rate may be performed for a single CC, for a group of CCs (for example, for CCs within a band, or for CCs within a band combination, or for CCs in a frequency range (e.g., FR1 or FR2)), or for all the CCs over which cells are currently serving the UE. As an example, the aggregated uplink data rate may be calculated in a similar manner as described above such that the condition for the aggregated uplink data rate across all CCs in a band or band combination in a slot may be defined as

$${\sum }_{j = 0}^{J - 1} \frac{{Σ}_{k = 0}^{K - 1} {V}_{j , k}}{{T}_{slot}^{μ ( j )}} \leq DataRate ,$$

where K denotes the total number of PUSCH transmissions and/or repetitions on all CCs in a slot, DataRate denotes an upper-limit aggregated uplink data rate, and all other parameters are as described above (e.g., with reference to clause 6.1.4 of 3GPP TS 38.214 v16.2.0). Note that each actual repetition is counted separately in this example, which allows the UE to treat each actual repetition as an independent transmission from the UE processing point of view. FIG. 10 shows an example of a slot in which K=5 (e.g., three actual repetitions of PUSCH A on CC1, a PUSCH transmission instance B on CC2, and a PUSCH transmission instance C on CC2).

The operation flow/algorithmic structure 1100 may include, at block 1120, determining not to transmit at least one uplink transmission instance among the plurality of uplink transmission instances, based on a comparison between the calculated aggregated uplink data rate and an upper-limit aggregated uplink data rate. The upper-limit uplink data rate may be the same as if PUSCH repetition Type B is not implemented. For example, the upper-limit aggregated uplink data rate may be based on one or more capabilities of UE 104, such as the maximum number of supported MIMO layers, the maximum modulation order, the maximum bandwidth for the serving cell (e.g., with or without a scaling factor applied), and/or a scaling factor. Block 1116 may also be implemented to include calculating an uplink data rate of the UE over a first actual repetition for the uplink transmission (e.g., as described herein with reference to block 812). Additionally or alternatively, block 1116 may also be implemented to include calculating an uplink effective code rate of the UE over a first actual repetition for the uplink transmission (e.g., as described herein with reference to block 712).

Techniques of applying an upper limit to the aggregated data rate (e.g., as described above with reference to FIGS. 9-11) may also be implemented such that each actual repetition is still counted separately, but a scaling factor is applied (e.g., for each actual repetition). Variations as described above (e.g., in terms of the time duration and/or the number of CCs) may also be applied to such cases.

In one such example, the condition for the aggregated uplink data rate across all CCs in a band or band combination in a slot may be defined as

$${\sum }_{j = 0}^{J - 1} \frac{{Σ}_{k = 0}^{K - 1} {a}_{k} {V}_{j , k}}{{T}_{slot}^{μ ( j )}} \leq DataRate$$

for the aggregated data rate across all CCs in a band or band combination in a slot, where the scaling factor αₖ to be applied to a particular actual repetition k can be determined based on pre-defined rules. For example, the scaling factor αₖ=1 if the PUSCH is not PUSCH repetition Type B, or if the actual repetition k is the first actual repetition of a PUSCH repetition Type B in the slot; and otherwise the scaling factor αₖ=γ (where γ has a value less than one, which may be pre-defined or reported by the UE based on a UE implementation) if the actual repetition k is the subsequent actual repetition of a PUSCH repetition Type B in a slot. Such scaling may be appropriate if the UE is implemented such that the subsequent actual repetition (e.g., k>0) shares certain processing with the first actual repetition (e.g., k=0) and therefore does not need to be fully counted towards the data rate limit.

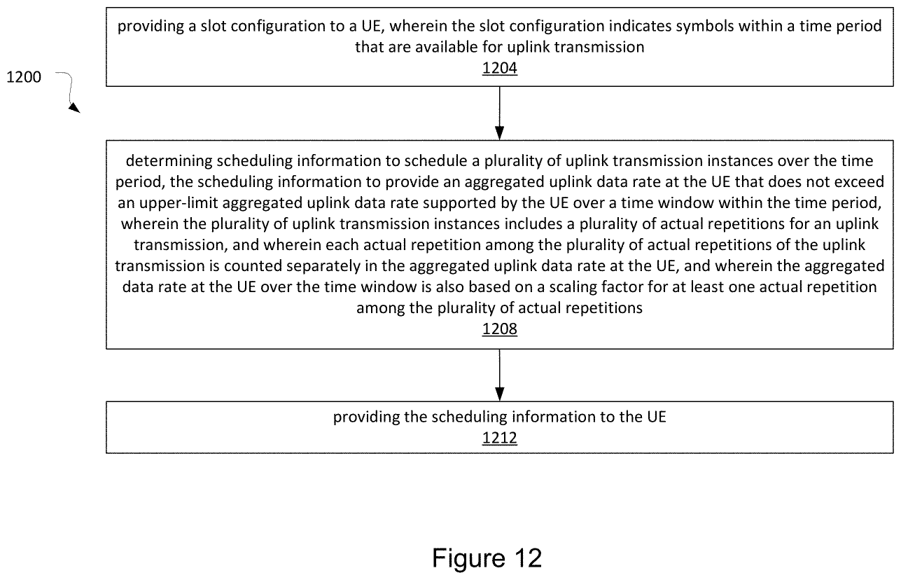

FIG. 12 illustrates an operation flow/algorithmic structure 1200 in accordance with some embodiments. The operation flow/algorithmic structure 1200 may be performed or implemented by a base station such as, for example, base station 108 or 2000; or components thereof, for example, baseband processor 2004A.

The operation flow/algorithmic structure 1200 may include blocks 1204, 1208, and 1212, which may be similar to blocks 904, 908, and 912, respectively, as described above with respect to FIG. 9. However, in block 1208, the aggregated data rate at the UE over the time window is also based on a scaling factor for at least one actual repetition among the plurality of actual repetitions. For example, the scaling factor may have a value less than one, and/or the scaling factor for one of the actual repetitions among the plurality of actual repetitions may differ from a scaling factor for another one of the actual repetitions among the plurality of actual repetitions. Block 1208 may also be implemented to include determining the scheduling information to provide an uplink data rate at the UE that does not exceed an upper-limit uplink data rate supported by the UE during any of the plurality of actual repetitions (e.g., as described herein with reference to block 608). Additionally or alternatively, block 1208 may also be implemented to include determining the scheduling information to provide an uplink effective code rate at the UE that does not exceed an upper-limit uplink effective code rate supported by the UE during any of the plurality of actual repetitions (e.g., as described herein with reference to block 508).

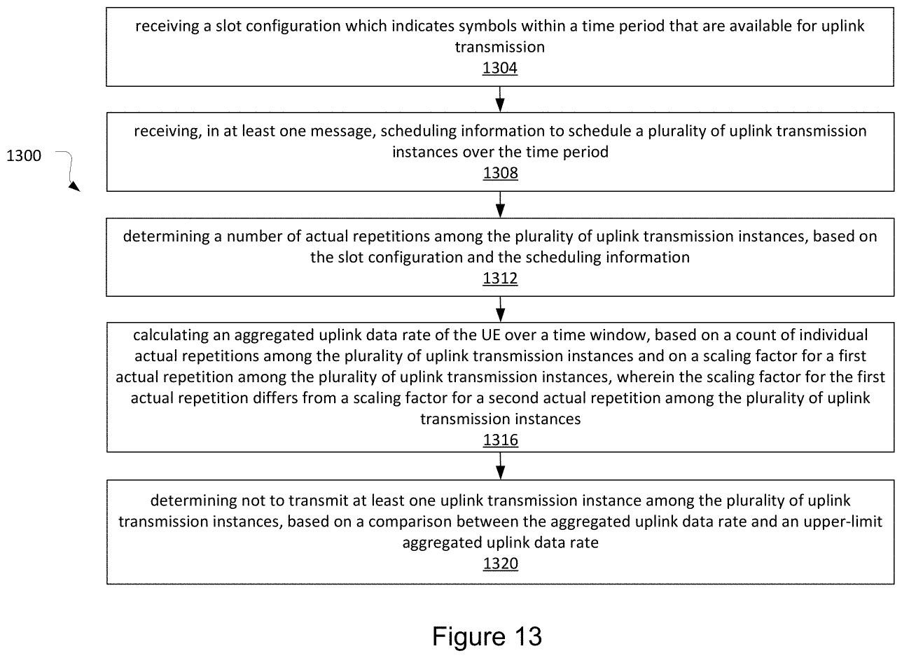

FIG. 13 illustrates an operation flow/algorithmic structure 1300 in accordance with some embodiments. The operation flow/algorithmic structure 1300 may be performed or implemented by a UE such as, for example, UE 104 or UE 1900; or components thereof, for example, baseband processor 1904A.

The operation flow/algorithmic structure 1300 may include blocks 1304, 1308, 1312, 1316, and 1320, which may be similar to blocks 1104, 1108, 1112, 1116, and 1120, respectively, as described above with respect to FIG. 11. However, in block 1316, calculating the aggregated data rate of the UE over the time window also includes applying a scaling factor for a first actual repetition among the plurality of uplink transmission instances. For example, the scaling factor may have a value less than one, and/or the scaling factor for the first actual repetition may differ from a scaling factor for another one of the actual repetitions.

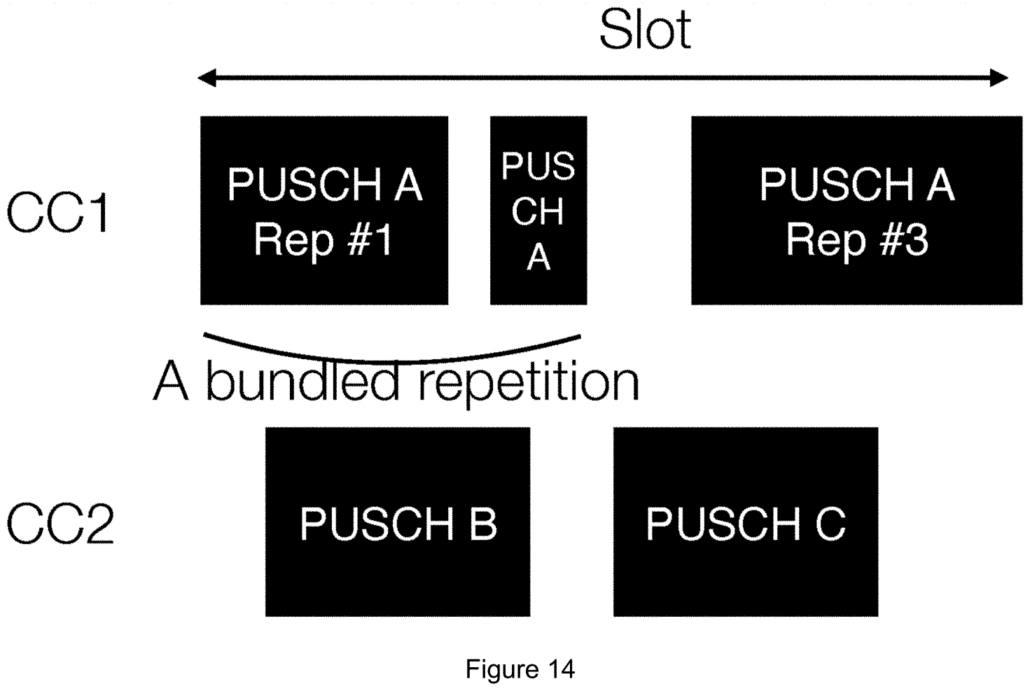

Techniques of applying an upper limit to the aggregated data rate (e.g., as described above with reference to FIGS. 9-13) may also be implemented such that two or more repetitions may be considered together as a bundle and counted only once towards the aggregated data rate. FIG. 14 shows an example in which PUSCH repetition #1 and #2 are considered as a “bundled” repetition, and the transport block is counted only once for the two repetitions. In this example, the number of TBs is K=4 for the two CCs.

Such modification of the aggregated data rate calculation may be appropriate for a case in which the two repetitions are “bundled” together, for example, by mapping one transmission with a given RV into the bundled resources, especially if one repetition has a short duration and results in a very high code rate. Such a bundling operation may allow a UE to process the two repetitions by treating them as a single transmission. Variations as described above (e.g., in terms of the time duration, the number of CCs, and/or scaling factors) may also be applied to such cases.

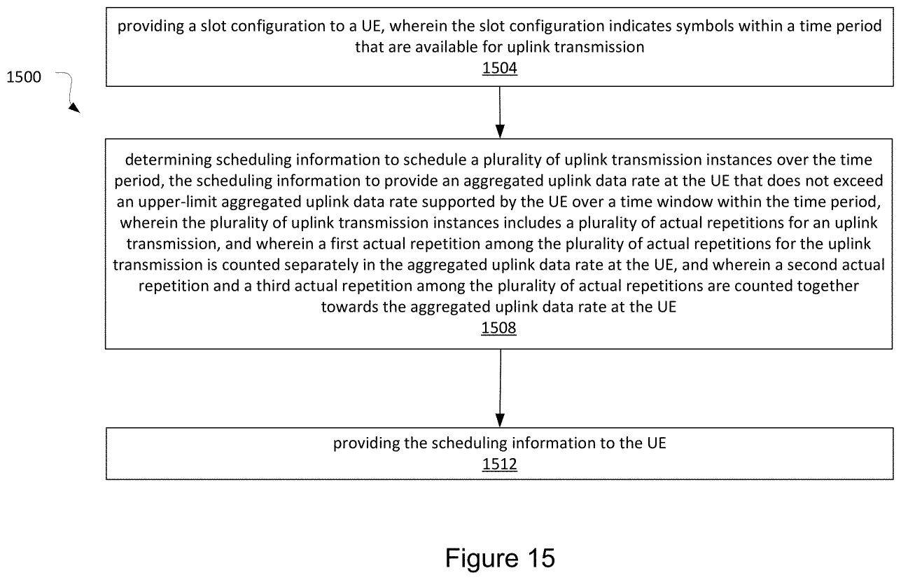

FIG. 15 illustrates an operation flow/algorithmic structure 1500 in accordance with some embodiments. The operation flow/algorithmic structure 1500 may be performed or implemented by a base station such as, for example, base station 108 or 2000; or components thereof, for example, baseband processor 2004A.

The operation flow/algorithmic structure 1500 may include blocks 1504 and 1512, which may be similar to blocks 904 and 912, respectively, as described above with respect to FIG. 9. The operation flow/algorithmic structure 1500 may also include, at block 1508, determining scheduling information to schedule a plurality of uplink transmission instances over the time period, the scheduling information to provide an aggregated uplink data rate at the UE that does not exceed an upper-limit aggregated uplink data rate supported by the UE over a time window within the time period, wherein the plurality of uplink transmission instances includes a plurality of actual repetitions for an uplink transmission, and wherein a first actual repetition among the plurality of actual repetitions of the uplink transmission is counted separately in the aggregated uplink data rate at the UE, and wherein a second actual repetition and a third actual repetition among the plurality of actual repetitions are counted together towards the aggregated uplink data rate at the UE. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. Calculating the aggregated uplink data rate may be performed for a single CC, for a group of CCs (for example, for CCs within a band, or for CCs in a frequency range (e.g., FR1 or FR2)), or for all the CCs over which cells are currently serving the UE. For example, calculating the aggregated uplink data rate may be performed as described above with reference to block 908, with K being modified to account for bundling as described herein. Block 1508 may also be implemented to include determining the scheduling information to provide an uplink data rate at the UE that does not exceed an upper-limit uplink data rate supported by the UE during any of the plurality of actual repetitions (e.g., as described herein with reference to block 608). Additionally or alternatively, block 1508 may also be implemented to include determining the scheduling information to provide an uplink effective code rate at the UE that does not exceed an upper-limit uplink effective code rate supported by the UE during any of the plurality of actual repetitions (e.g., as described herein with reference to block 508).

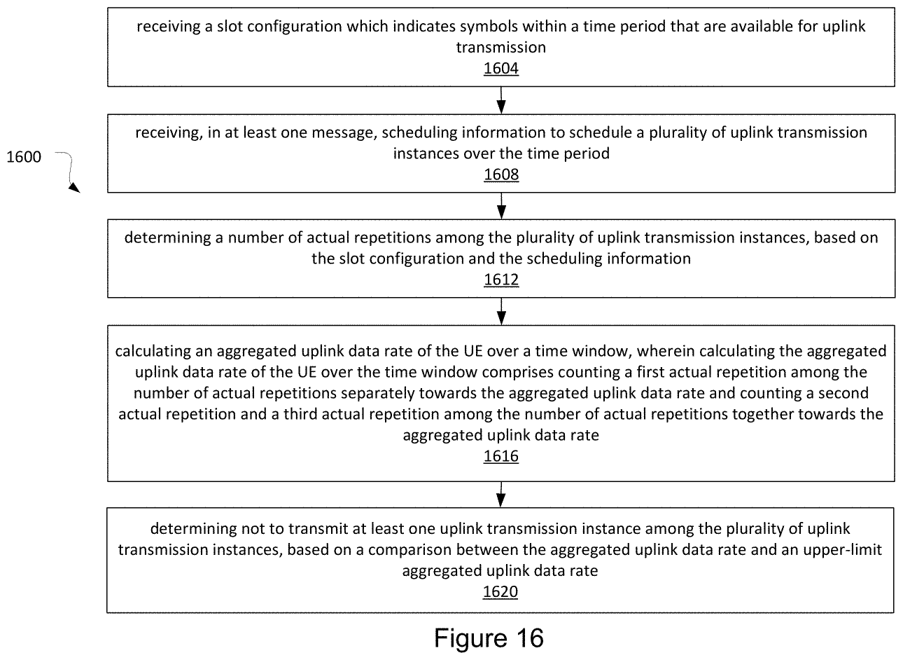

FIG. 16 illustrates an operation flow/algorithmic structure 1600 in accordance with some embodiments. The operation flow/algorithmic structure 1600 may be performed or implemented by a UE such as, for example, UE 104 or UE 1900; or components thereof, for example, baseband processor 1904A.

The operation flow/algorithmic structure 1600 may include blocks 1604, 1608, 1612, and 1620, which may be similar to blocks 1104, 1108, 1112, and 1120, respectively, as described above with respect to FIG. 11. The operation flow/algorithmic structure 1600 may also include, at block 1616, calculating an aggregated uplink data rate of the UE over a time window, wherein calculating the aggregated data rate of the UE over the time window includes counting a first actual repetition for the uplink transmission separately towards the aggregated uplink data rate and counting a second actual repetition for the uplink transmission and a third actual repetition for the uplink transmission together towards the aggregated uplink data rate. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. Calculating the aggregated uplink data rate may be performed for a single CC, for a group of CCs (for example, for CCs within a band, or for CCs in a frequency range (e.g., FR1 or FR2)), or for all the CCs over which cells are currently serving the UE. For example, calculating the aggregated uplink data rate may be performed as described above with reference to block 1116, with K being modified to account for bundling as described herein. Block 1616 may also be implemented to include calculating an uplink data rate of the UE over a first actual repetition for the uplink transmission (e.g., as described herein with reference to block 812). Additionally or alternatively, block 1616 may also be implemented to include calculating an uplink effective code rate of the UE over a first actual repetition for the uplink transmission (e.g., as described herein with reference to block 712).

For any of the techniques disclosed herein, an actual repetition may be fully or partially cancelled in case of intra-UE prioritization (e.g., due to another higher priority transmission) or inter-UE cancellation (e.g., due to the reception of the UL cancellation indication). If an actual repetition is fully cancelled, such a technique may be implemented to count the cancelled repetition towards the aggregated data rate or, alternatively, such a technique may be implemented to not count the cancelled repetition towards the aggregated data rate. If an actual repetition is partially cancelled, for a case in which the aggregated data rate is calculated over a time window that is defined based on the duration of an actual repetition, the time window may be defined based on either the original duration of the actual repetition (e.g., before cancellation) or the duration of the actual repetition after partial cancellation.

As noted above, even though the techniques described herein are formulated in the context of PUSCH repetition Type B, similar issues may arise for PDSCH supporting a similar repetition scheme (for example, an implementation in which PDSCH with mini-slot repetition is supported for multi-transmission/reception points (multi-TRP)). Techniques of applying an upper limit on a per-repetition data rate and/or effective code rate as described herein (e.g., with reference to structures 500, 600, 700, and/or 800) may also be applicable to each PDSCH repetition. Such techniques may be especially useful if the duration of each PDSCH repetition may be smaller than the nominal duration that is used to determine the TBS. Techniques of applying an upper limit on an aggregated data rate as described herein (e.g., with reference to structures 900, 1100, 1200, 1300, 1500, or 1600) may also applied to the aggregated data rate of multiple PDSCHs.

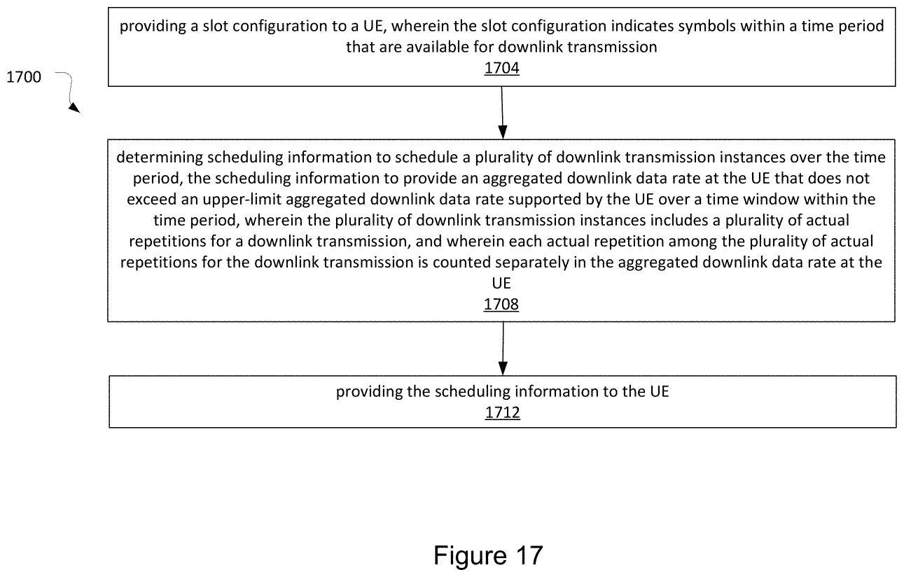

FIG. 17 illustrates an operation flow/algorithmic structure 1700 in accordance with some embodiments. The operation flow/algorithmic structure 1700 may be performed or implemented by a base station such as, for example, base station 108 or 2000; or components thereof, for example, baseband processor 2004A.

The operation flow/algorithmic structure 1700 may include, at block 1704, providing a slot configuration to a UE, wherein the slot configuration indicates symbols within a time period (e.g., one or more slots) that are available for downlink transmission.

The operation flow/algorithmic structure 1700 may include, at block 1708, determining scheduling information to schedule a plurality of downlink transmission instances over the time period, the scheduling information to provide an aggregated downlink data rate at the UE that does not exceed an upper-limit aggregated downlink data rate supported by the UE over a time window within the time period. The plurality of downlink transmission instances may include a plurality of actual repetitions for a downlink transmission, and each actual repetition among the plurality of actual repetitions for the downlink transmission may be counted separately in the aggregated downlink data rate at the UE. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. The scheduling information may include, for example, a time domain resource allocation, a modulation and coding scheme, and/or a frequency resource allocation. The scheduling information may indicate that the actual repetitions for the downlink transmission are for on a first carrier, and the plurality of downlink transmission instances may also include at least one downlink transmission instance for a second carrier that is different from the first carrier. Determining the scheduling information may include, for example, calculating the aggregated downlink data rate at the UE over the time window and/or verifying that the aggregated downlink data rate does not exceed the upper-limit aggregated downlink data rate supported by the UE. Calculating the aggregated downlink data rate may be performed for a single CC, for a group of CCs (for example, for CCs within a band, or for CCs in a frequency range (e.g., FR1 or FR2)), or for all the CCs over which cells are currently serving the UE.

The operation flow/algorithmic structure 1700 may include, at block 1712, providing the scheduling information to the UE in, for example, one or more messages (e.g., one or more DCI messages). Block 1708 may also be implemented to include determining the scheduling information to provide an downlink data rate at the UE that does not exceed an upper-limit downlink data rate supported by the UE during any of the plurality of actual repetitions (e.g., in an analogous manner as described herein with reference to an uplink data rate at block 608). Additionally or alternatively, block 1708 may also be implemented to include determining the scheduling information to provide a downlink effective code rate at the UE that does not exceed an upper-limit downlink effective code rate supported by the UE during any of the plurality of actual repetitions (e.g., in an analogous manner as described herein with reference to an uplink effective code rate at block 508).

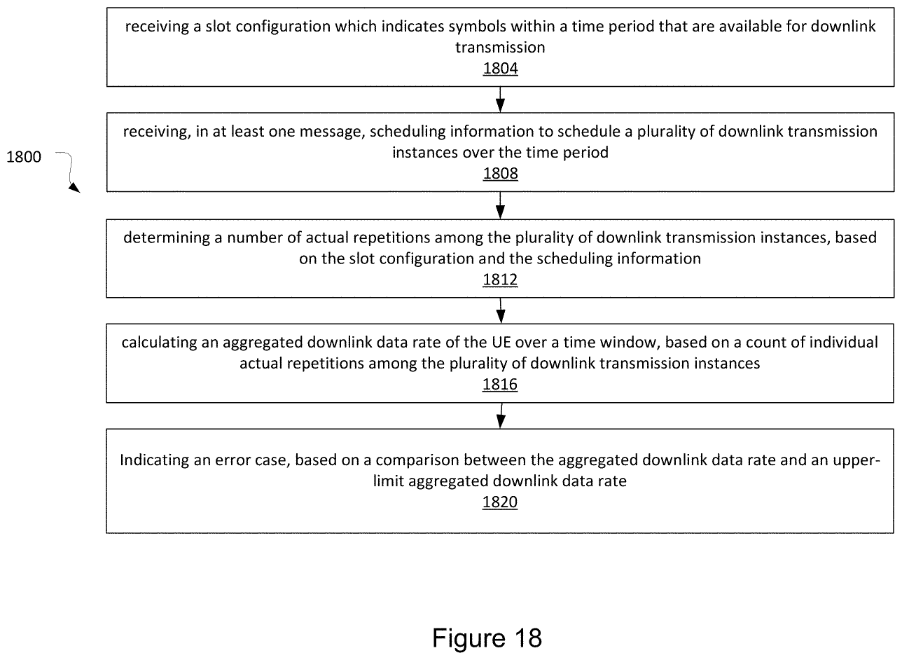

FIG. 18 illustrates an operation flow/algorithmic structure 1800 in accordance with some embodiments. The operation flow/algorithmic structure 1800 may be performed or implemented by a UE such as, for example, UE 104 or UE 1900; or components thereof, for example, baseband processor 1904A.

The operation flow/algorithmic structure 1800 may include, at block 1804, receiving a slot configuration which indicates symbols within a time period (e.g., one or more slots) that are available for downlink transmission. The operation flow/algorithmic structure 1100 may include, at block 1108, receiving, in at least one message (e.g., in at least one DCI message), scheduling information to schedule a plurality of downlink transmission instances over the time period. The scheduling information may include, for example, a time domain resource allocation, a modulation and coding scheme, and/or a frequency resource allocation.

The operation flow/algorithmic structure 1800 may include, at block 1812, determining a number of actual repetitions for a downlink transmission (e.g., a PDSCH transmission) among the plurality of downlink transmission instances, based on the slot configuration and the scheduling information. The number of actual repetitions within the time period may be greater than a number of nominal repetitions within the time period that is indicated by the scheduling information (e.g., by the time domain resource allocation). The scheduling information may indicate that the actual repetitions of the downlink transmission are for on a first carrier, and the plurality of downlink transmission instances may also include at least one downlink transmission instance for a second carrier that is different from the first carrier.

The operation flow/algorithmic structure 1800 may include, at block 1816, calculating an aggregated downlink data rate of the UE over a time window, based on a count of individual actual repetitions of the number of actual repetitions. For example, calculating the aggregated downlink data rate of the UE over the time window may include counting each actual repetition among the number of actual repetitions separately towards the aggregated downlink data rate. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. Calculating the aggregated downlink data rate may be performed for a single CC, for a group of CCs (for example, for CCs within a band, or for CCs in a frequency range (e.g., FR1 or FR2)), or for all the CCs over which cells are currently serving the UE.

The operation flow/algorithmic structure 1800 may include, at block 1820, indicating an error case, based on a comparison between the calculated aggregated downlink data rate and an upper-limit aggregated downlink data rate. The indicating an error case may include, for example, determining not to process (e.g., determining not to decode or otherwise to handle) at least one actual repetition among the number of actual repetitions. The upper-limit downlink data rate may be the same as if such a downlink repetition scheme is not implemented. For example, the upper-limit aggregated downlink data rate may be based on one or more capabilities of UE 104, such as the maximum number of supported MIMO layers, the maximum modulation order, the maximum bandwidth for the serving cell (e.g., with or without a scaling factor applied), and/or a scaling factor. Structure 1800 may also be implemented to include calculating a downlink data rate of the UE over a first actual repetition for the downlink transmission (e.g., in an analogous manner as described herein with reference to an uplink data rate at block 812) and indicating an error case based on a comparison between the downlink data rate and an upper-limit downlink data rate. Additionally or alternatively, structure 1800 may also be implemented to include calculating an downlink effective code rate of the UE over a first actual repetition for the downlink transmission (e.g., in an analogous manner as described herein with reference to an uplink effective code rate at block 712) and indicating an error case based on a comparison between the downlink effective code rate and an upper-limit downlink effective code rate.

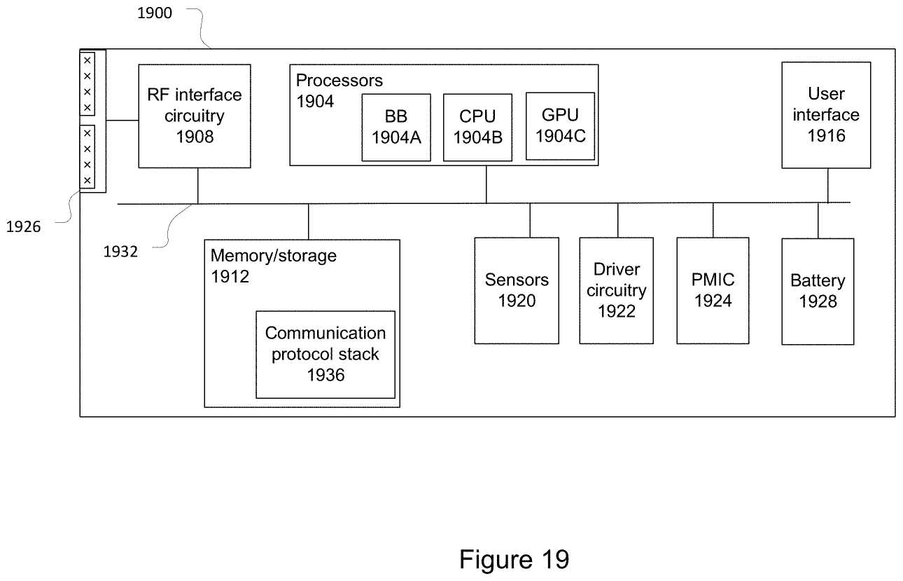

FIG. 19 illustrates a UE 1900 in accordance with some embodiments. The UE 1900 may be similar to and substantially interchangeable with UE 104 of FIG. 1.

The UE 1900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1900 may include processors 1904, RF interface circuitry 1908, memory/storage 1912, user interface 1916, sensors 1920, driver circuitry 1922, power management integrated circuit (PMIC) 1924, antenna structure 1926, and battery 1928. The components of the UE 1900 may be implemented as integrated circuits (ICs), portions thereof, discrete electronic devices, or other modules, logic, hardware, software, firmware, or a combination thereof. The block diagram of FIG. 19 is intended to show a high-level view of some of the components of the UE 1900. However, some of the components shown may be omitted, additional components may be present, and different arrangement of the components shown may occur in other implementations.

The components of the UE 1900 may be coupled with various other components over one or more interconnects 1932, which may represent any type of interface, input/output, bus (local, system, or expansion), transmission line, trace, optical connection, etc. that allows various circuit components (on common or different chips or chipsets) to interact with one another.

The processors 1904 may include processor circuitry such as, for example, baseband processor circuitry (BB) 1904A, central processor unit circuitry (CPU) 1904B, and graphics processor unit circuitry (GPU) 1904C. The processors 1904 may include any type of circuitry or processor circuitry that executes or otherwise operates computer-executable instructions, such as program code, software modules, or functional processes from memory/storage 1912 to cause the UE 1900 to perform operations as described herein.

In some embodiments, the baseband processor circuitry 1904A may access a communication protocol stack 1936 in the memory/storage 1912 to communicate over a 3GPP compatible network. In general, the baseband processor circuitry 1904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1908.

The baseband processor circuitry 1904A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1912 may include one or more non-transitory, computer-readable media that includes instructions (for example, communication protocol stack 1936) that may be executed by one or more of the processors 1904 to cause the UE 1900 to perform various operations described herein. The memory/storage 1912 include any type of volatile or non-volatile memory that may be distributed throughout the UE 1900. In some embodiments, some of the memory/storage 1912 may be located on the processors 1904 themselves (for example, L1 and L2 cache), while other memory/storage 1912 is external to the processors 1904 but accessible thereto via a memory interface. The memory/storage 1912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1908 may include transceiver circuitry and radio frequency front module (RFEM) that allows the UE 1900 to communicate with other devices over a radio access network. The RF interface circuitry 1908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1926 and proceed to filter and amplify (with a low-noise amplifier) the signal. The signal may be provided to a receiver of the transceiver that down-converts the RF signal into a baseband signal that is provided to the baseband processor of the processors 1904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1926.

In various embodiments, the RF interface circuitry 1908 may be configured to transmit/receive signals in a manner compatible with NR access technologies.

The antenna 1926 may include antenna elements to convert electrical signals into radio waves to travel through the air and to convert received radio waves into electrical signals. The antenna elements may be arranged into one or more antenna panels. The antenna 1926 may have antenna panels that are omnidirectional, directional, or a combination thereof to enable beamforming and multiple input, multiple output communications. The antenna 1926 may include microstrip antennas, printed antennas fabricated on the surface of one or more printed circuit boards, patch antennas, phased array antennas, etc. The antenna 1926 may have one or more panels designed for specific frequency bands including bands in FR1 or FR2.

The user interface circuitry 1916 includes various input/output (I/O) devices designed to enable user interaction with the UE 1900. The user interface 1916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1900.

The sensors 1920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1922 may include software and hardware elements that operate to control particular devices that are embedded in the UE 1900, attached to the UE 1900, or otherwise communicatively coupled with the UE 1900. The driver circuitry 1922 may include individual drivers allowing other components to interact with or control various input/output (I/O) devices that may be present within, or connected to, the UE 1900. For example, driver circuitry 1922 may include a display driver to control and allow access to a display device, a touchscreen driver to control and allow access to a touchscreen interface, sensor drivers to obtain sensor readings of sensor circuitry 1920 and control and allow access to sensor circuitry 1920, drivers to obtain actuator positions of electro-mechanic components or control and allow access to the electro-mechanic components, a camera driver to control and allow access to an embedded image capture device, audio drivers to control and allow access to one or more audio devices.

The PMIC 1924 may manage power provided to various components of the UE 1900. In particular, with respect to the processors 1904, the PMIC 1924 may control power-source selection, voltage scaling, battery charging, or DC-to-DC conversion.

In some embodiments, the PMIC 1924 may control, or otherwise be part of, various power saving mechanisms of the UE 1900 including DRX as discussed herein.

A battery 1928 may power the UE 1900, although in some examples the UE 1900 may be mounted deployed in a fixed location, and may have a power supply coupled to an electrical grid. The battery 1928 may be a lithium ion battery, a metal-air battery, such as a zinc-air battery, an aluminum-air battery, a lithium-air battery, and the like. In some implementations, such as in vehicle-based applications, the battery 1928 may be a typical lead-acid automotive battery.

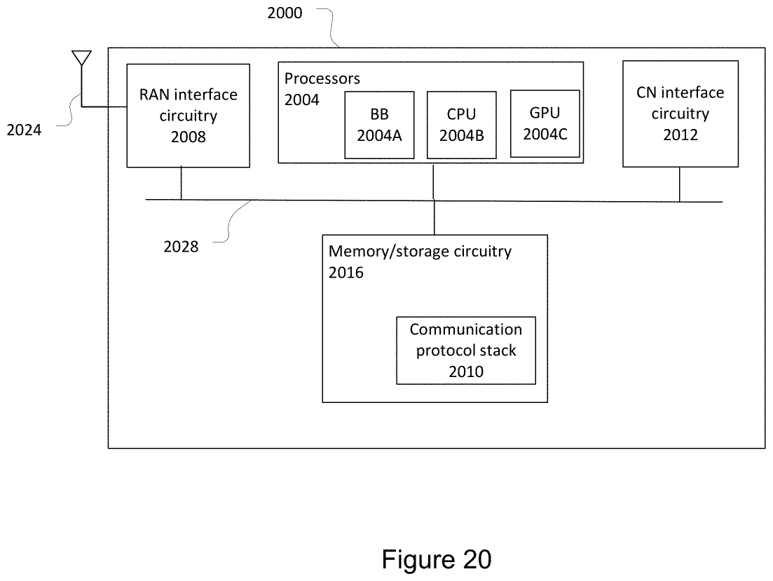

FIG. 20 illustrates an access node 2000 (e.g., a base station or gNB) in accordance with some embodiments. The access node 2000 may be similar to and substantially interchangeable with access node 108.

The access node 2000 may include processors 2004, RF interface circuitry 2008, core network (CN) interface circuitry 2012, memory/storage circuitry 2016, and antenna structure 2026.

The components of the access node 2000 may be coupled with various other components over one or more interconnects 2028.

The processors 2004, RF interface circuitry 2008, memory/storage circuitry 2016 (including communication protocol stack 2010), antenna structure 2026, and interconnects 2028 may be similar to like-named elements shown and described with respect to FIG. 19.

The CN interface circuitry 2012 may provide connectivity to a core network, for example, a 5th Generation Core network (5GC) using a 5GC-compatible network interface protocol such as carrier Ethernet protocols, or some other suitable protocol. Network connectivity may be provided to/from the access node 2000 via a fiber optic or wireless backhaul. The CN interface circuitry 2012 may include one or more dedicated processors or FPGAs to communicate using one or more of the aforementioned protocols. In some implementations, the CN interface circuitry 2012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes one or more non-transitory computer-readable media having instructions that, when executed by one or more processors, cause a base station to provide a slot configuration to a user equipment (UE), wherein the slot configuration indicates symbols within a time period that are available for uplink transmission; determine scheduling information to schedule a plurality of uplink transmission instances over the time period, the scheduling information to provide an uplink data rate at the UE that does not exceed an upper-limit uplink data rate supported by the UE during any of a plurality of actual repetitions among the plurality of uplink transmission instances, wherein a duration of a first actual repetition for an uplink transmission among the plurality of actual repetitions is less than a duration of a nominal repetition of the uplink transmission that is indicated by the scheduling information; and provide the scheduling information to the UE.

Example 2 includes the one or more non-transitory computer-readable media of Example 1 or some other example herein, wherein the scheduling information comprises a time domain resource allocation, a modulation and coding scheme, or a frequency resource allocation.

Example 3 includes the one or more non-transitory computer-readable media of Example 1 or some other example herein, wherein the slot configuration and the scheduling information provide a schedule in which the duration of the first actual repetition is less than a duration of a second actual repetition for the uplink transmission among the plurality of actual repetitions.

Example 4 includes the one or more non-transitory computer-readable media of Example 3 or some other example herein, wherein the instructions, when executed by the one or more processors, cause the base station to determine the scheduling information by causing the base station to calculate an uplink data rate of the UE over the first actual repetition.

Example 5 includes the one or more non-transitory computer-readable media of Example 1 or some other example herein, wherein the instructions, when executed by the one or more processors, further cause the base station to receive a capability of the UE; and calculate the upper-limit uplink data rate supported by the UE based in part on the capability.

Example 6 includes the one or more non-transitory computer-readable media of Example 5 or some other example herein, wherein the capability indicates a maximum number of supported multiple-input multiple-output (MIMO) layers, a maximum modulation order, a maximum bandwidth for a serving cell, or a scaling factor.

Example 7 includes the one or more non-transitory computer-readable media of Example 1 or some other example herein, wherein the instructions, when executed by the one or more processors, further cause the base station to determine the scheduling information so that an upper-limit uplink effective code rate supported by the UE is not exceeded during any of the plurality of actual repetitions.

Example 8 includes the one or more non-transitory computer-readable media of Example 1 or some other example herein, wherein the instructions that, when executed by the one or more processors, cause the base station to provide the scheduling information to the UE comprise instructions that, when executed by the one or more processors, cause the base station to provide at least part of the scheduling information to the UE in a downlink control information message.

Example 9 includes a method of operating a user equipment (UE), the method comprising receiving a slot configuration that indicates symbols within a time period that are available for uplink transmission; receiving, in at least one message, scheduling information to schedule a plurality of uplink transmission instances over the time period; calculating an uplink data rate of the UE over a first actual repetition for an uplink transmission among the plurality of uplink transmission instances; and determining not to transmit at least one uplink transmission instance among the plurality of uplink transmission instances, based on a comparison between the uplink data rate and an upper-limit uplink data rate, wherein a duration of the first actual repetition is less than a duration of a second actual repetition for the uplink transmission among the plurality of uplink transmission instances.

Example 10 includes the method of Example 9 or some other example herein, wherein the scheduling information comprises a time domain resource allocation that indicates a duration of a nominal repetition of the uplink transmission within the time period, and wherein a duration of the first actual repetition is less than the duration of the nominal repetition.

Example 11 includes the method of Example 9 or some other example herein, wherein determining not to transmit at least one uplink transmission instance among the plurality of uplink transmission instances comprises determining not to transmit the first actual repetition.

Example 12 includes the method of Example 9 or some other example herein, wherein the uplink data rate of the UE is based in part on a capability of the UE, wherein the capability indicates a maximum number of supported multiple-input multiple-output (MIMO) layers, a maximum modulation order, a maximum bandwidth for a serving cell, or a scaling factor.

Example 13 includes the method of Example 9 or some other example herein, wherein determining not to transmit the at least one uplink transmission instance among the plurality of uplink transmission instances is further based on a comparison between an uplink effective code data rate of the UE over the actual repetition and an upper-limit uplink effective code rate.

Example 14 includes the method of Example 9 or some other example herein, wherein determining not to transmit the at least one uplink transmission instance among the plurality of uplink transmission instances is further based on a comparison between an aggregated uplink data rate of the UE over a time window and an upper-limit aggregated uplink data rate.

Example 15 includes a user equipment (UE) comprising processing circuitry to receive a slot configuration which indicates symbols within a time period that are available for uplink transmission; receive, in at least one message, scheduling information to schedule a plurality of uplink transmission instances over the time period; determine a number of actual repetitions for an uplink transmission among the plurality of uplink transmission instances, based on the slot configuration and the scheduling information; calculate an aggregated uplink data rate of the UE over a time window, based on a count of individual actual repetitions for the uplink transmission; and determine not to transmit at least one uplink transmission instance among the plurality of uplink transmission instances, based on a comparison between the aggregated uplink data rate and an upper-limit aggregated uplink data rate; and memory coupled to the processing circuitry, the memory to store the slot configuration.

Example 16 includes the UE of Example 15 or some other example herein, wherein the scheduling information comprises a time domain resource allocation that indicates a number of nominal repetitions within the time period, and wherein the number of actual repetitions is greater than the number of nominal repetitions.

Example 17 includes the UE of Example 15 or some other example herein, wherein the processing circuitry is further to receive at least part of the scheduling information to the UE in a downlink control information message.

Example 18 includes the UE of Example 15 or some other example herein, wherein the aggregated uplink data rate of the UE is based on at least one of a maximum number of supported multiple-input multiple-output (MIMO) layers, a maximum modulation order, a maximum bandwidth for a serving cell, or a scaling factor.

Example 19 includes the UE of Example 15 or some other example herein, wherein the scheduling information indicates that the actual repetitions for the uplink transmission are for a first carrier, and wherein the plurality of uplink transmission instances also comprises at least one uplink transmission instance for a second carrier that is different from the first carrier.

Example 20 includes the UE of Example 15 or some other example herein, wherein the processing circuitry is to calculate the aggregated uplink data rate of the UE based on a scaling factor for a first actual repetition for the uplink transmission, wherein the scaling factor for the first actual repetition differs from a scaling factor for a second actual repetition for the uplink transmission.

Example 21 includes one or more non-transitory computer-readable media having instructions that, when executed by one or more processors, cause a base station to provide a slot configuration to a user equipment (UE), wherein the slot configuration indicates symbols within a time period that are available for uplink transmission; determine scheduling information to schedule a plurality of uplink transmission instances over the time period, the scheduling information to provide an uplink effective code rate at the UE that does not exceed an upper-limit uplink effective code rate supported by the UE during any of a plurality of actual repetitions among the plurality of uplink transmission instances, wherein a duration of a first actual repetition for an uplink transmission among the plurality of actual repetitions is less than a duration of a nominal repetition of the uplink transmission that is indicated by the scheduling information; and provide the scheduling information to the UE.

Example 22 includes a method of operating a user equipment (UE), the method comprising receiving a slot configuration that indicates symbols within a time period that are available for uplink transmission; receiving, in at least one message, scheduling information to schedule a plurality of uplink transmission instances over the time period; calculating an uplink effective code rate of the UE over a first actual repetition for an uplink transmission among the plurality of uplink transmission instances; and determining not to transmit at least one uplink transmission instance among the plurality of uplink transmission instances, based on a comparison between the uplink effective code rate and an upper-limit uplink effective code rate, wherein a duration of the first actual repetition is less than a duration of a second actual repetition for the uplink transmission among the plurality of uplink transmission instances.

Example 23 includes a method of operating a base station, the method comprising providing a slot configuration to a UE, wherein the slot configuration indicates symbols within a time period (e.g., one or more slots) that are available for uplink transmission; determining scheduling information to schedule a plurality of uplink transmission instances over the time period, the scheduling information to provide an aggregated uplink data rate at the UE that does not exceed an upper-limit aggregated uplink data rate supported by the UE over a time window within the time period; and providing the scheduling information to the UE in, for example, one or more messages (e.g., one or more DCI messages). The plurality of uplink transmission instances may include a plurality of actual repetitions for an uplink transmission, and each actual repetition among the plurality of actual repetitions for the uplink transmission may be counted separately in the aggregated uplink data rate at the UE. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. The scheduling information may include, for example, a time domain resource allocation, a modulation and coding scheme, and/or a frequency resource allocation. The scheduling information may indicate that the plurality of actual repetitions are for a first carrier, and the plurality of uplink transmission instances may also include at least one uplink transmission instance for a second carrier that is different from the first carrier. Determining the scheduling information may include, for example, calculating the aggregated uplink data rate at the UE over the time window and/or verifying that the aggregated uplink data rate does not exceed the upper-limit aggregated uplink data rate supported by the UE.

Example 24 includes a user equipment (UE) comprising processing circuitry to receive a slot configuration which indicates symbols within a time period that are available for downlink transmission; receive, in at least one message, scheduling information to schedule a plurality of downlink transmission instances over the time period; determine a number of actual repetitions for an downlink transmission among the plurality of downlink transmission instances, based on the slot configuration and the scheduling information; calculate an aggregated downlink data rate of the UE over a time window, based on a count of individual actual repetitions for the downlink transmission; and determine not to transmit at least one downlink transmission instance among the plurality of downlink transmission instances, based on a comparison between the aggregated downlink data rate and an upper-limit aggregated downlink data rate; and memory coupled to the processing circuitry, the memory to store the slot configuration.

Example 25 includes a method of operating a base station, the method comprising providing a slot configuration to a UE, wherein the slot configuration indicates symbols within a time period (e.g., one or more slots) that are available for downlink transmission; determining scheduling information to schedule a plurality of downlink transmission instances over the time period, the scheduling information to provide an aggregated downlink data rate at the UE that does not exceed an upper-limit aggregated downlink data rate supported by the UE over a time window within the time period; and providing the scheduling information to the UE in, for example, one or more messages (e.g., one or more DCI messages). The plurality of downlink transmission instances may include a plurality of actual repetitions for an downlink transmission, and each actual repetition among the plurality of actual repetitions for the downlink transmission may be counted separately in the aggregated downlink data rate at the UE. The time window may be, for example, a slot, a sliding window with a fixed duration, the duration of an actual repetition, the duration of a nominal repetition, the combined durations of all the actual repetitions within a slot, or the combined duration of all the nominal repetitions within a slot. The scheduling information may include, for example, a time domain resource allocation, a modulation and coding scheme, and/or a frequency resource allocation. The scheduling information may indicate that the plurality of actual repetitions are for a first carrier, and the plurality of downlink transmission instances may also include at least one downlink transmission instance for a second carrier that is different from the first carrier. Determining the scheduling information may include, for example, calculating the aggregated downlink data rate at the UE over the time window and/or verifying that the aggregated downlink data rate does not exceed the upper-limit aggregated downlink data rate supported by the UE.

Example 26 may include an apparatus comprising means to perform one or more elements of a method described in or related to any of examples 1-25, or any other method or process described herein.

Example 27 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example 28 may include an apparatus comprising logic, modules, or circuitry to perform one or more elements of a method described in or related to any of examples 1-25, or any other method or process described herein.

Example 29 may include a method, technique, or process as described in or related to any of examples 1-25, or portions or parts thereof.

Example 30 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example 31 may include a signal as described in or related to any of examples 1-25, or portions or parts thereof.

Example 32 may include a datagram, information element, packet, frame, segment, PDU, or message as described in or related to any of examples 1-25, or portions or parts thereof, or otherwise described in the present disclosure.

Example 33 may include a signal encoded with data as described in or related to any of examples 1-25, or portions or parts thereof, or otherwise described in the present disclosure.

Example 34 may include a signal encoded with a datagram, IE, packet, frame, segment, PDU, or message as described in or related to any of examples 1-25, or portions or parts thereof, or otherwise described in the present disclosure.

Example 35 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example 36 may include a computer program comprising instructions, wherein execution of the program by a processing element is to cause the processing element to carry out the method, techniques, or process as described in or related to any of examples 1-25, or portions thereof.

Example 37 may include a signal in a wireless network as shown and described herein.

Example 38 may include a method of communicating in a wireless network as shown and described herein.

Example 39 may include a system for providing wireless communication as shown and described herein.

Example 40 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors, cause a base station to:
provide a slot configuration to a user equipment (UE), wherein the slot configuration indicates symbols within a time period that are available for uplink transmission;
determine scheduling information to schedule a plurality of uplink transmission instances over the time period, the scheduling information to provide an uplink data rate at the UE that does not exceed an upper-limit uplink data rate supported by the UE during any of a plurality of actual repetitions among the plurality of uplink transmission instances, wherein a duration of a first actual repetition for an uplink transmission among the plurality of actual repetitions is less than a duration of a nominal repetition of the uplink transmission that is indicated by the scheduling information; and
provide the scheduling information to the UE.

2. The one or more non-transitory computer-readable media of claim 1, wherein the scheduling information comprises a time domain resource allocation, a modulation and coding scheme, or a frequency resource allocation.

3. The one or more non-transitory computer-readable media of claim 1, wherein the instructions, when executed by the one or more processors, further cause the base station to determine the scheduling information so that an upper-limit aggregated uplink data rate supported by the UE is not exceeded over a time window.

4. The one or more non-transitory computer-readable media of claim 3, wherein the instructions, when executed by the one or more processors, cause the base station to determine the scheduling information by causing the base station to calculate an uplink data rate of the UE over the first actual repetition.

5. The one or more non-transitory computer-readable media of claim 1, wherein the instructions, when executed by the one or more processors, further cause the base station to:
receive a capability of the UE; and
calculate the upper-limit uplink data rate supported by the UE based in part on the capability.

6. The one or more non-transitory computer-readable media of claim 5, wherein the capability indicates a maximum number of supported multiple-input multiple-output (MIMO) layers, a maximum modulation order, a maximum bandwidth for a serving cell, or a scaling factor.

7. The one or more non-transitory computer-readable media of claim 1, wherein the instructions, when executed by the one or more processors, further cause the base station to determine the scheduling information so that an upper-limit uplink effective code rate supported by the UE is not exceeded during any of the plurality of actual repetitions.

8. The one or more non-transitory computer-readable media of claim 1, wherein the instructions that, when executed by the one or more processors, cause the base station to provide the scheduling information to the UE comprise instructions that, when executed by the one or more processors, cause the base station to provide at least part of the scheduling information to the UE in a downlink control information message.

9. A method of operating a user equipment (UE), the method comprising:
receiving a slot configuration that indicates symbols within a time period that are available for uplink transmission;
receiving, in at least one message, scheduling information to schedule a plurality of uplink transmission instances over the time period;
calculating an uplink data rate of the UE over a first actual repetition for an uplink transmission among the plurality of uplink transmission instances; and
determining not to transmit at least one uplink transmission instance among the plurality of uplink transmission instances, based on a comparison between the uplink data rate and an upper-limit uplink data rate,
wherein a duration of the first actual repetition is less than a duration of a second actual repetition for the uplink transmission among the plurality of uplink transmission instances.

10. The method of claim 9, wherein the scheduling information comprises a time domain resource allocation that indicates a duration of a nominal repetition of the uplink transmission within the time period, and
wherein a duration of the first actual repetition is less than the duration of the nominal repetition.

11. The method of claim 9, wherein determining not to transmit at least one uplink transmission instance among the plurality of uplink transmission instances comprises determining not to transmit the first actual repetition.

12. The method of claim 9, wherein the upper-limit uplink data rate of the UE is based in part on a capability of the UE, wherein the capability indicates a maximum number of supported multiple-input multiple-output (MIMO) layers, a maximum modulation order, a maximum bandwidth for a serving cell, or a scaling factor.

13. The method of claim 9, wherein determining not to transmit the at least one uplink transmission instance among the plurality of uplink transmission instances is further based on a comparison between an uplink effective code data rate of the UE over the actual repetition and an upper-limit uplink effective code rate.

14. The method of claim 9, wherein determining not to transmit the at least one uplink transmission instance among the plurality of uplink transmission instances is further based on a comparison between an aggregated uplink data rate of the UE over a time window and an upper-limit aggregated uplink data rate.

15. A user equipment (UE) comprising:
processing circuitry to:
receive a slot configuration which indicates symbols within a time period that are available for uplink transmission;
receive, in at least one message, scheduling information to schedule a plurality of uplink transmission instances over the time period;
determine a number of actual repetitions for an uplink transmission among the plurality of uplink transmission instances, based on the slot configuration and the scheduling information;
calculate an aggregated uplink data rate of the UE over a time window, based on a count of individual actual repetitions for the uplink transmission; and
determine not to transmit at least one uplink transmission instance among the plurality of uplink transmission instances, based on a comparison between the aggregated uplink data rate and an upper-limit aggregated uplink data rate; and
memory coupled to the processing circuitry, the memory to store the slot configuration.

16. The UE of claim 15, wherein the scheduling information comprises a time domain resource allocation that indicates a number of nominal repetitions within the time period, and
wherein the number of actual repetitions is greater than the number of nominal repetitions.

17. The UE of claim 15, wherein the processing circuitry is further to receive at least part of the scheduling information to the UE in a downlink control information message.

18. The UE of claim 15, wherein the upper-limit aggregated uplink data rate of the UE is based on at least one of a maximum number of supported multiple-input multiple-output (MIMO) layers, a maximum modulation order, a maximum bandwidth for a serving cell, or a scaling factor.

19. The UE of claim 15, wherein the scheduling information indicates that the actual repetitions for the uplink transmission are for occur on a first carrier, and
wherein the plurality of uplink transmission instances also comprises at least one uplink transmission instance for a second carrier that is different from the first carrier.

20. The UE of claim 15, wherein the processing circuitry is to calculate the aggregated uplink data rate of the UE based on a scaling factor for a first actual repetition for the uplink transmission, wherein the scaling factor for the first actual repetition differs from a scaling factor for a second actual repetition for the uplink transmission.
